(19) United States
(12) Patent Application Publication
(10) Pub. No.: US 2001/0003542 A1
(43) Pub. Date: Jun. 14, 2001

(54) Earphone-type music reproducing device and music reproducing system using the device

(76) Inventor: Kazunori Kita, Tokyo (JP)

Correspondence Address: FRISHAUF, HOLTZ, GOODMAN, LANGER & CHICK, P.C., 25th Floor, 767 Third Avenue, New York, NY, 10017, US

(21) Appl. No.: 09/725,400

(22) Filed: Nov. 29, 2000

(30) Foreign Application Priority Data
Dec. 14, 1999 (JP) 355114 / 1999

(51) Int. Cl. H04R 1/02

(52) U.S. Cl. 381/334

(57) ABSTRACT

An headphone-type music reproducing device and music reproducing system bearable even during a user's exercise for use and capable of reproducing desired music easily and rapidly by manipulating a wristband-type remote control device worn on the user's wrist. In the headphone-type music reproducing device, a memory card which prestores music data is removable set in a headphone body born over the user's ears. A music data decoder provided within the body reproduces a music signal based on the music data stored in the memory card. When a radio transmission/reception unit receives a remote control signal sent by a wristband-type remote control device, the headphone-type music reproducing device reproduces and/or stops music based on the music signal in accordance with the received remote control signal.

### BACKGROUND OF THE INVENTION

The present invention relates to earphone-type music reproducing devices and music reproducing systems, and more particularly to an earphone-type music reproducing device and a music reproducing system which comprises the earphone-type music reproducing device and a wrist device worn on an user's wrist.

Portable music reproducing apparatus have been used. In such apparatus, a storage medium such as a magnetic tape or an optical disk such as a CD or MD which prestores music data is set to reproduce the music data in a reproducing system corresponding to the storage medium, and corresponding music is from earphones or headphones. In order to reproduce or stop the music, a switch provided on the apparatus body is operated or a remote control unit provided in the earphone cord is used.

As semiconductor memories are formed of integrated circuits of an increasing density at a decreasing cost, portable music reproducing apparatus which use a semiconductor memory card comprising a small removable non-volatile memory as a music data storage medium have been developed. Such portable music reproducing apparatus decrease in size and have resistance to vibration/shocks, and improved portability.

In such music reproducing apparatus, however, an earphone cord which connects the apparatus body and the earphones or headphones is troublesome to handle, and is liable to be caught by objects present around the apparatus body, so that the apparatus cannot be used during sports or outdoor exercise.

It is presupposed that the portable music reproducing apparatus is carried in a bag or pocket, and that after it is taken out from the bag or pocket, the switch provided on the apparatus body is operated to reproduce or stop the music. When a remote control device connected to the earphone cord is operated, the remote control device is difficult to fix at a fixed position and hence to manipulate. Thus, it takes much time to operate the apparatus and the apparatus cannot be operated within a crowded train as the case may be.

The present invention solves such problems. It is an object of the present invention to provide a headphone-type music reproducing device and a music reproducing system usable by a user in a state where the reproducing device is worn on the user's wrist even during the user's exercise, and capable of rapidly reproducing music easily by manipulating the device worn on the user's wrist.

### SUMMARY OF THE INVENTION

In order to achieve the above object, the present invention provides a music reproducing apparatus comprising:

a body wearable over a user's ear (for example, earphone body 3100A of FIG. 5; earphone 3105 of FIG. 6A.);

a semiconductor music data storage device (for example, small memory card 209 of FIG. 5) provided removably within the body and prestoring music data;

music reproducing means (for example, music data decoder 211 and music output unit 212 of FIG. 6A) provided within the body for reproducing music based on music data stored in the music data storage device;

receiving means (for example, radio transmission and reception unit 3103 of FIG. 3103) provided within the body for receiving a remote control signal externally; and

music reproduction control means (for example, control unit 3102 of FIG. 6A) for controlling reproduction of music in the music reproducing means based on the remote control signal received by the receiving means.

According to this music reproducing apparatus, music is reproduced by the music reproducing means based on music data stored in the music data storage device which is provided removably in the body wearable over the user's ear. The music reproduction control means is responsive to the receiving means receiving the remote control signal externally to control reproduction of music in the music reproducing means based on the remote control signal.

Thus, since the semiconductor music data storage means and the music reproducing means are provided in the apparatus body, the user is able to listen to the music without preparing a music reproducing device separate from the apparatus body. The user is able to listen to music only with the music reproducing apparatus even during strong sports or outdoor jogging without being troubled with an earphone cord as occurred in the past. Since music reproduction is controlled in accordance with a remote control signal received externally, removing the headphone-type music reproducing apparatus is not required from the user's ear for manipulating purposes. As a result, the music reproducing apparatus achieves being wearable for use even during the user's exercise and being manipulatable for rapidly and easily reproducing desired music.

The present invention also provides a music reproducing system (for example, music reproducing system 3000 of FIG. 5) comprising an earphone-type music reproducing device (for example, earphone-type music reproducing device 3100 of FIG. 5) and a wristband-type remote control device (for example, wristband-type remote control device 3200 of FIG. 5),

a body wearable over a user's ear (for example, earphone body 3100A of FIG. 5; . 6 3105 of FIG A);

a semiconductor music data storage device (for example, small memory card 209 of FIG. 5) provided removably within the body and prestoring music data;

music reproducing means (for example, music data decoder 211 and music output unit 212 of FIG. 6A) provided within the body for reproducing music based on music data stored in the music data storage device;

receiving means (for example, radio transmission and reception unit 3103 of FIG. 3103) provided within the body for receiving a remote control signal the wristband-type remote control device; and

music reproduction control means (for example, control unit 3102 of FIG. 6A) for controlling reproduction of music in the music reproducing means based on the remote control signal received by the receiving means.

the wristband-type remote control device comprising;

input means (for example, input means 202 of FIGS. 5 and 6B)for inputting data to remotely control reproduction of music in the earphone type music reproducing device; and

sending means(for example, radio transmission and reception unit 3202 of FIG. 6B) for sending the earphone-type music reproducing device a remote control signal to remotely control reproduction of the music based on the data input by the input means.

This music reproducing system comprises the earphone-type music reproducing device and the wristband-type remote control device. In the earphone-type music reproducing device, the music reproducing means reproduces music based on music data stored in the music data storage device which is provided removably within the body worn over the user's ear and prestoring music data. When the receiving means receives a remote control signal from the wristband-type remote control device, the music reproduction control means controls reproduction of music in the music reproducing means based on the remote control signal received by the receiving means. In the wristband-type remote control device, when the input means inputs data to remotely control reproduction of music in the earphone-type music reproducing device, the sending means sends the earphone-type music reproducing device a remote control signal based on the data input by the input means to remotely control reproduction of the music.

Thus, since the music data storage means and the music reproducing means are provided in the apparatus body, music is produced even if no other music reproducing device separate from the apparatus body is prepared. Thus, this apparatus provides high portability. The user is able to rapidly manipulate the wristband-type remote control device worn on the user's wrist for music reproduction. Thus, the apparatus body is neither required to be taken off the user's ears or nor is the remote control device required to be taken out, for example, from the user's jacket pocket in order to manipulate the apparatus to input an instruction of music reproduction. If the remote control device is worn on the user's wrist, the position of the remote control device is easily fixed in the manipulation, and the manipulation is rapidly performed. As a result, a music reproducing system is provided which is wearable even during the user's exercise and manipulatable rapidly and easily at the position of the user's wrist for reproducing desired music.

In this system, earphone-type music reproducing device may further comprise data transmitting means (for example, radio transmission and reception unit 3103 of FIG. 6A) for transmitting to the wristband-type remote control device information on music reproduced by the music reproducing means. The wristband-type remote control device may comprise:

a display unit (for example, display unit 201 of FIG. 5);

data receiving means (for example, radio transmission and reception unit 3202 of FIG. 6B) for receiving information on the music sent by the earphone-type music reproducing device; and

display control means (for example, control unit 3201 of FIG. 6B) for displaying on the display unit information on the music received by the data receiving means.

Thus, in the earphone-type music reproducing device of the music reproducing system, the data transmitting means transmits to the wristband-type remote control device information on music reproduced by the music reproducing means. In the wristband-type remote control device, when the data receiving means receives information on the music sent by the earphone-type music reproducing device, the display control means displays on the display unit information on the music received by the data receiving means.

Thus, information on the music reproduced by the earphone-type music reproducing device is displayed on the display unit at hand and confirmed easily. In addition, the music reproducing device can be easily manipulated at hand for music reproduction while confirming the information on the music, which provides easy manipulation.

In this case, the remote control signal and the information on the music may be wirelessly sent/received between the earphone-type music reproducing device and the wristband-type remote control device.

Thus, the user is not troubled with an earphone cord which connects the earphone-type music reproducing device and the wristband-type remote control device, and hence the music reproducing device can be used comfortably during strong exercise or outdoor jogging.

The wristband-type remote control device may comprise:

a display unit (for example, display unit 201 of FIGS. 5 and 6B);

timepiece means for counting time (for example, timepiece 207 of FIG. 6B); and

display control means (for example, control unit 3201 of FIG. 6B)for causing the display unit to display the time counted by the timepiece means.

According to this music reproducing system, since the wristbandtype remote control device counts time with the timepiece means and displays the counted time with the display control means, the user is able to confirm the time by viewing the wristband-type remote control device worn on the user's wrist.

The wristband-type remote control device may comprise:

mode setting means (for example, mode switches 203 of FIG. 5) for setting one of a timepiece mode and a music mode; and

control means (for example, control unit 3201 of FIG. 6B), responsive to the mode setting means setting the timepiece mode, for controlling the wristband-type remote control device to display the time counted by the timepiece means on the display unit, and responsive to the mode setting means setting the music mode, for controlling the wristband-type remote control device to enable data to be inputted to the input means.

Thus, in the wristband-type remote control device, the mode setting means sets one of the timepiece and music modes. The control means is responsive to the mode setting means setting the timepiece mode to control the wristband-type remote control device to display the time counted by the timepiece means on the display unit, and responsive to the mode setting means setting the music mode to control the wristband-type remote control device to enable data to be inputted to the input means.

Thus, one of the time display and the music reproducing operation is performed instantaneously in accordance with a selecting operation of the mode setting means with the wristband-type remote control device being worn the user's wrist.

The present invention also provides a music reproducing system (for example, music reproducing system 2000 of FIGS. 1, 2 and 4) comprising an earphone-type music hearing device (for example, headphones 2100 of FIGS. 1 and 2B; headphones 2300 of FIG. 4B) for enabling the user to listen to music, and a wristband-type music reproducing device (for example, wristband-type music reproducing device 2200 of FIGS. 1 and 2A; wristband-type music reproducing device 2400 of FIG. 4A) wearable on the user's wrist,

the wristband-type music reproducing device comprising:

music data storage means for prestoring music data device (for example, memory card 209 of FIGS. 2A and 4A;

input means (for example, input unit 202 of FIG. 1) for inputting data to reproduce music;

music reproducing means (for example, music data decoder 211 of FIGS. 2A and 4A; music output unit 212 of FIG. 4A) for reproducing a music signal based on music data stored in the music data storage means in accordance with the data to reproduce music which is input by the input means; and

radio transmitting means (for example, radio transmission unit 2202 of FIG. 2A; radio transmission adapter 2500 of FIG. 4A) for wirelessly transmitting the music signal reproduced by the music reproducing means to the earphone-type music hearing device, and

the earphone-type music hearing device comprising:

receiving means (for example, radio reception unit 2101 of FIG. 2B; radio reception unit 2301 of FIG. 4B) for receiving the music signal sent by the radio transmitting means; and

music output means (for example, music output unit 2102 of FIG. 2B; music output unit 2302 of FIG. 4B) for outputting music based on the music signal received by the receiving means.

This music reproducing system comprises the earphone-type music hearing device and the wristband-type music reproducing device wearable on the user's wrist. In the wristband-type music reproducing device, the music data storage means prestores music data device. When the input means inputs data to reproduce music, the music reproducing means reproduces a music signal based on music data stored in the music data storage means in accordance with the data to reproduce music which is input by the input means. The radio transmitting means wirelessly transmits the music signal reproduced by the music reproducing means to the earphone-type music hearing device. In the earphone-type music hearing device, when the receiving means receives the music signal sent by the radio transmitting means, the music output means outputs music based on the music signal received by the receiving means.

Thus, since the wristband-type music reproducing device worn on the user's wrist comprises the music reproducing means and the input means for music reproduction, the wristband-type music reproducing device worn on the user's wrist is manipulatable for music reproduction to reproduce desired music from the earphone-type music hearing device. When the wristband-type music reproducing device is worn on the user's wrist, its position is easily fixed when the wristband-type music reproducing device is manipulated. Thus, rapid manipulation can be made. Since reproduction music data is wirelessly transmitted to the earphone-type music hearing device, the user is not troubled with an earphone cord which connects the earphone-type music hearing device and the wristband-type music reproducing device, and can comfortably use the wristband-type music reproducing device even during strong exercise or outdoor sports. That is, the music reproducing system is usable even during exercise and capable of reproducing a desired piece of music rapidly and easily by manipulating the wristband-type music reproducing device worn on the user's wrist.

In this case, the radio transmitting means (for example,radio transmission adapter 2500 of FIG. 4A) may be provided removably in the wristband-type music reproducing device.

Thus, the wristband-type music reproducing device itself is constructed compactly, and the music reproducing system is used in a manner which the user desires. That is, when music is to be reproduced, the radio transmitting means is attached to the wristband-type music reproducing device, reproduction music data is wirelessly sent to the earphone-type music hearing device, from which the user can hear the music. When no music is reproduced, the radio transmitting means is removed from the wristband-type music reproducing device, and the wristband-type music reproducing device is worn the user's wrist as a general wristwatch for carrying the music reproducing device compactly.

The wristband-type music reproducing device may comprise:

a display unit (for example, display unit 201 of FIG. 1);

display control means (for example, control unit 2201 of FIG. 2A; control unit 2401 of FIG. 4A) for causing the display unit to display information on the music signal reproduced by the music reproducing means.

According to this wristband-type music reproducing device, since the display control means displays on the display unit information on the music to be reproduced by the music reproducing means, the user can easily confirm the information at hand. Since the user can manipulate the wristband-type music reproducing device at hand while viewing the information, the manipulation is easily performed.

The wristband-type remote control device may comprise:

a display unit (for example, display unit 201 of FIG. 1);

timepiece means for counting time (for example, timepiece 207 of FIGS. 2A and 4A); and

display control means (for example, control unit 2201 of FIG. 2A; control unit 2401 of FIG. 4A) for causing the display unit to display the time counted by the timepiece means.

According to this music reproducing system, the wristband-type music reproducing device counts time data with the timepiece means and the display control means displays the counted time data on the display unit. Thus, the user is able to confirm the time by viewing the wristband-type music reproducing device worn on the user's wrist.

The wristband-type remote control device may comprise:

mode setting means (for example, mode switches 203 of FIG. 1) for setting one of a timepiece mode and a music mode; and

control means (for example, control unit 2201 of FIG. 2A; control unit 2401 of FIG. 4A), responsive to the mode setting means setting the timepiece mode, for controlling the wristband-type remote control device to display the time counted by the timepiece means on the display unit, and responsive to the mode setting means setting the music mode, for controlling the wristband-type remote control device to enable the music reproducing means to reproduce music or to enable data to be inputted to the input means.

In this case, in this wristband-type remote control device, the mode setting means sets one of the timepiece and music modes. The control means is responsive to the mode setting means setting the timepiece mode to control the wristband-type remote control device to display on the display unit the time counted by the timepiece means, and responsive to the mode setting means setting the music mode to control the wristband-type remote control device to enable the music reproducing means to reproduce music.

Thus, in response to the mode selecting operation by the mode setting means, one of the time display and music reproduction can be performed instantaneously with the wristband-type music reproducing device being worn on the user's wrist.

### BRIEF DESCRIPTION OF THE DRAWINGS

FIG. 1 shows the appearances of a headphones 2100 and a wristband-type music reproducing device 2200 which compose a music reproducing system 2000 as a first embodiment;

FIG. 2A is a block diagram of the wristband-type music reproducing device 2200;

FIG. 2B is a block diagram of the headphones 2100;

FIGS. 3A, B and C each illustrate an example of use of the music reproducing system 2000;

FIGS. 4A and B are block diagrams of a wristband-type music reproducing device 2400 and a headphones 2300, respectively, which compose a music reproducing system 2000A as a second embodiment;

FIG. 5 shows the appearances of a headphone-type music reproducing device 3100 and a wristband-type music reproducing apparatus 3200 which compose a music reproducing system 3000 as a third embodiment;

FIGS. 6A and B are block diagrams of the headphone-type music reproducing device 3100 and the wristband-type music reproducing device 3200, respectively;

FIG. 7 is a block diagram of a music reproducing system which comprises an external device 800 and the wristband-type music reproducing device 2400 connected thereto;

FIG. 8A illustrates the wristband-type music reproducing device 2200 connected through an external device 820 to a server 902 for reception of music data from the server;

FIG. 8B illustrates the wristband-type music reproducing device 2200 connected through an external device 820 or a mobile communication terminal 914 to a server 902;

FIG. 8C illustrates the wristband-type music reproducing device 2200 which receives music data through a memory card 209 in a personal computer 820 or kiosk 915 from a server 902;

FIG. 9A illustrates that the wristband-type music reproducing device 2200 or 2400 wirelessly receives music data through an external device 800 or a communication terminal 914 and a base station 913 from a server 902;

FIG. 9B illustrates that the wristband-type music reproducing device 2200 or 2400 wirelessly receives music data through a mobile communication terminal 914 or a data kiosk 915 from a server 902;

FIG. 9C illustrates that the wristband-type music reproducing device 2200 or 2400 wirelessly receives music data from a server 902 through a base station 914 or a broadcasting station 916 in a mobile terminal communication network 917;

FIG. 10 is a block diagram of a ciphered music data confirming and decoding system which comprises an external device 800, memory card 209 and wristband-type or music reproducing device 2200, 2400 or 3100 connected sequentially in this order;

FIG. 11 is a block diagram of a music reproducing system which comprises an external device 800 and the wristband-type music reproducing device 2400 connected thereto, each comprising image data encoding and decoding functions;

FIG. 12A shows an appearance of an earphone-type music reproducing device 2700A as another embodiment; and

FIG. 12B shows a pair of earphone-type music reproducing devices connected by a cord as a further embodiment.

### DETAILED DESCRIPTION OF THE PREFERRED EMBODIMENTS

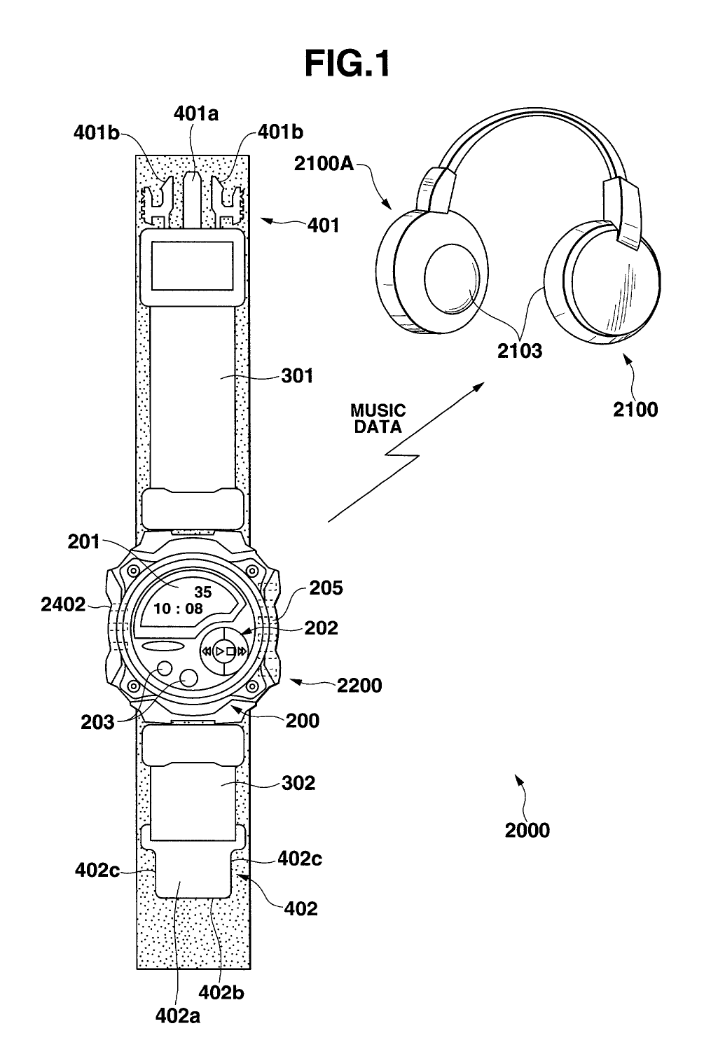

Referring to FIGS. 1-12, a first embodiment of a music reproducing system according to the present invention will be described next.

### First Embodiment

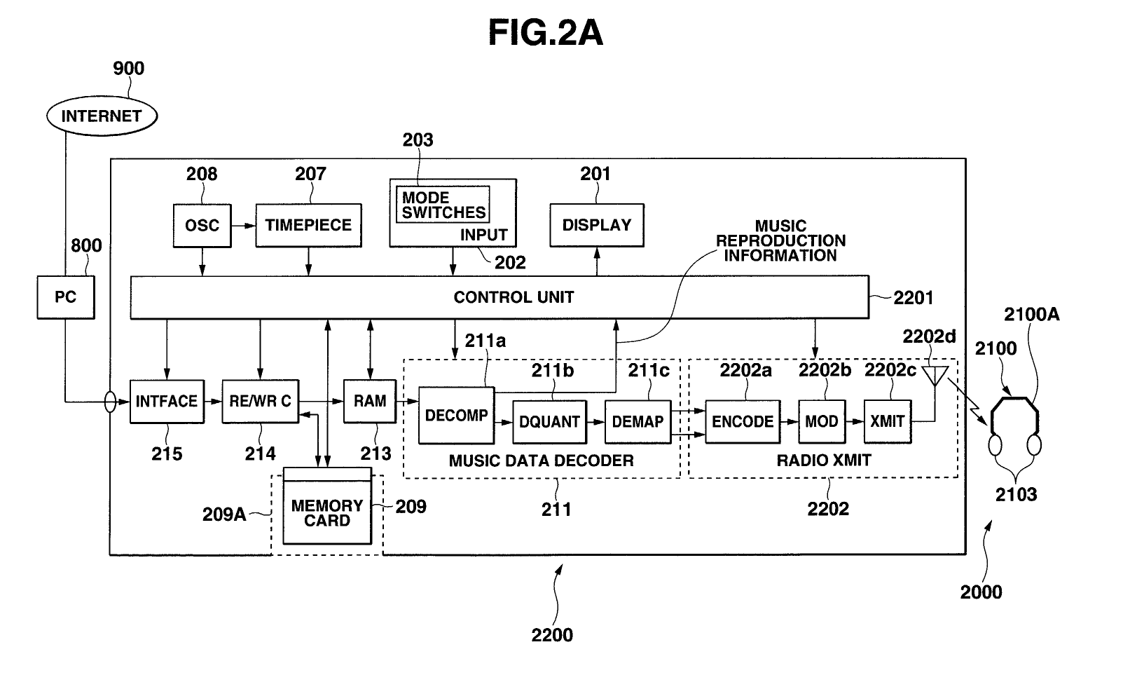

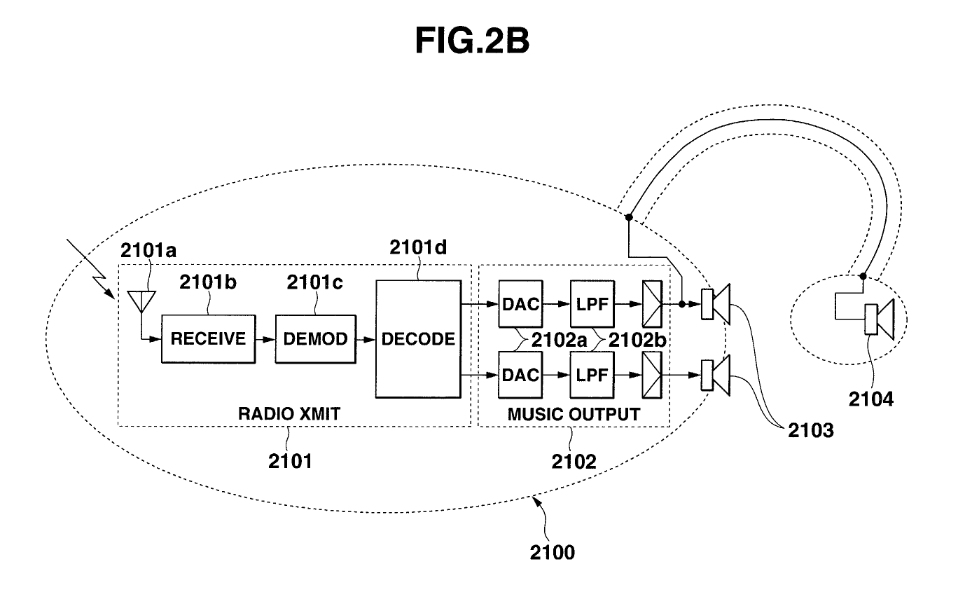

First, referring to FIGS. 1-3, the music reproducing system 2000 comprises a wristband-type music reproducing device 2200 which, in turn, comprises a body case 200. The body case contains the internal circuit of FIG. 2A, a pair of wristbands 301, 302 each connected at one end to the body case 200, and a pair of buckles 401 and 402 each connected to a respective one of the other ends of the wristbands 301 and 302 so as to be worn on a user's wrist.

A display unit 201, an input unit 202 and a pair of mode switches 203 operated in mode setting are provided on an upper surface of the body case 200. The display unit 201 displays date data such as a present date and time in a timepiece mode, and data on music to be reproduced (music data No., music title, singer's name, performance time, song words, etc.) in a music mode.

The input unit 200 comprises a plurality of keys for keying in data on timepiece functions such as correction to the time in the timepiece mode and data on music reproduction such as reproduction, stop, rewind and fast-feed for reproduction of music in the music mode. A signal produced when a key is depressed is delivered to a control unit 2201.

The pair of mode switches 203 each are used to set a respective one of the timepiece and music modes. When one of the mode switches is depressed, a corresponding signal is delivered to the control unit 2201, which upon detecting the signal, selects a corresponding mode in which the device 2200 is operable.

The body case 200 has on its side a pair of connectors 205 and 2402 for connection to an external device and a radio transmission adapter, respectively. The external device connector 205 has terminals receiving data from an external device such as a personal computer (PC) 800. The data (compressed encoded music data) received from the external device 800 is written into a memory card 209, which prestores a plurality of music data, set in a receiving area 209A in the body case 200 under control of a read/write control unit 214 to be described later.

The radio transmission adapter connector 2402 is used to connect thereto a radio transmission adapter 2500 to be described later in a second embodiment through which connector music data provided by a music data decoder 211 and a music output unit 212 is sent to the radio transmission adapter 2500.

A back cover (not shown) prevents the memory card 209 set in the receiving section 209A from slipping off the receiver section 209A. The receiver section 209A has data read/write terminals (not shown) engaged with data read/write electrodes (not shown) provided on the memory card 209 when the memory card 209 is set in position such that access to the memory card 209 through the electrodes is controlled by a read/write control unit 214.

One buckle 402 comprises a hollow body 402a having a front opening 402b and its right and left openings 402c. The other buckle 401 insertable into the opening 402b of the buckle 401 comprises a central support tongue 401a and a pair of auxiliary flexible supports 401b each provided on a respective side of the tongue 401a. When the pair of auxiliary flexible supports 401b are somewhat pressed inward laterally and inserted sufficiently along with the central tongue 401a into the opening 402b in the buckle 402 and then released, the inward compressed pair of flexible supports 401b are outward laterally expanded to be engaged in the respective right and left openings 402c such that the pair of flexible supports 401b each appear outward out of a respective one of the pair of openings 402c.

When the buckle 401 is to be removed from the buckle 402, the first and second flexible supports 401b of the buckle 401 are pressed inward laterally with fingers of the user's right hand, they are removed from the openings 402c. Then, the buckle 401 is pulled out lengthwise from the buckle 402.

The headphones 2100 comprises a pair of bodies 2100A each having a shape wearable over the user's ear. The headphones 2100 comprises an electronic circuit of FIG. 2B which receives a music signal sent wirelessly by the wristband-type music reproducing device 2200, and which outputs corresponding music from a pair of headphone speakers 2103 provided in the corresponding bodies 2100A. In this case, when the digital music data decoded and wirelessly sent by the wristband-type music reproducing device 2200 is received by the radio receiver 2101, the music output unit 2102 converts it to analog music data, which is then output audibly from the pair of headphone speakers 2103 or the earphone 2104 connected to the headphones 2100.

Referring to FIGS. 2A and B, the circuit composition of the wristband-type music reproducing device 2200, headphones 2100 and a music reproducing system 2000 as the first embodiment which comprises the reproducing device 2200 and the headphones 2100 will be described next. The wristband-type music reproducing device 2200 comprises a display unit 201, an input unit 202 which includes mode switches 203, a timepiece 207, an oscillator 208, a control unit 2201, a music data decoder 211, a RAM having a music data memory 213, a read/write control unit 214, an external interface 215 and a radio transmitter 2202 with a removable memory card 209.

The control unit 2201 controls the respective components of the wristband-type music reproducing device 2200 to perform operation corresponding to a timepiece or music mode selected by a key-in signal provided by a corresponding one of the pair of mode switches 203.

In the timepiece mode, the control unit 2201 displays on the display unit 201 a date/time based on time data measured and provided by the timepiece 207, performs a timepiece function such as correction to the time in accordance with an instruction inputted at the input unit 202, and displays a result of the processing on the display unit 201.

In the music mode, the control unit 2201 reads the compressed encoded music data stored on the memory card 209 set in the receiving section 209A based on an instruction of reproduction inputted at the input unit 202, stores it in the music data memory 213, and reproduces corresponding music based on the music data. In this case, the control unit 2201 decodes the music data stored in the music data memory 213, sends it to the radio transmitter 2202, which encodes and modulates the msicdata for radio transmission, and which then sends it to the headphones 2100.

The control unit 2201 acquires the compressed encoded music data sent by the external device 800 via the external interface 215, and writes the acquired music data on the memory card 209 under control of the read/write control unit 214.

The external device 800 comprises a storage device (not shown) for storing music data, and a network connecting function such as a modem/LAN interface, accesses the Internet 900 to download the music data received externally, and then stores it in the storage device. The external device 800 is connected via an external adapter (not shown) to a connector 205 of the wristband-type music reproducing device 2200 to send the music data stored in the storage device to the wristband-type music reproducing device 2200 and write the data on the memory card 209.

The timepiece 207 sequentially sends counted date/time data to a time register (not shown) for updating purposes. The timepiece 207 comprises the oscillator 208 which generates an electric signal of a predetermined frequency and a frequency divider (not shown) which provides a signal of a different predetermined frequency so as to count the number of signals to provide a present time.

The music data decoder 211 decodes the music data compressed and encoded at an appropriate bit rate in a predetermined method so as to provide a high quality tone and efficient transmission. In this case, for example, an encoding method comprising an entropy encoding method using an acoustic characteristic according to MP3 (MPEG1 Audio Layer III) or a perceptual encoding system may be used. The decoder 211 decomposes the compressed encoded music data (bit stream) received from the music data memory 213 or memory card 209 into frames of an AAU (Audio Access Unit) in a frame decomposition unit 211a, detects possible errors involved, and then decodes the respective frames sequentially under control of the control unit 2201.

First, side information such as a frame header, bit allocation information and a scale factor is extracted from a first frame, and the audio data is dequantized in a dequantizer/encoder 211b based on the extracted scale factor and bit allocation information. Then, a subband is synthesized in a demapper 211c from the dequantized data, and delivered as a corresponding PCM (Pulse Code Modulation) output signal to the radio transmitter 2202.

The RAM (music data memory) 213 comprises a semiconductor music data memory which stores decoded reproduced music data and related information. The memory card 209 is a small semi-conductor memory which stores a plurality of music data received from an external device 800 such as a PC and related information such as a title of music, song words, a singer's name, and a performance time.

The read/write control unit 214 controls writing data received from the control unit 2201 in RAM 213 or on memory card 209. Also, in response to reproduction of music, the read/write control unit 214 reads music data to be reproduced from among the music data stored in the memory card 209 and writes it to the music data memory 213.

The external interface 215 acquires music data transmitted from the external device 800 via the external connector 205 and transmits the music data to the read/write control unit 214 under control of the control unit 2201.

The radio transmitter 2202 encodes in an encoder 2202a the PCM output signal (digital music data) decoded in the music data decoder 211 for radio transmission, modulates it in a modulator 2202b and sends a resulting signal in a transmission unit 2202c from an antenna 2202d to the headphones 2100.

The internal circuit of the headphones 2100 of FIG. 2B comprises a radio receiver 2101, a music output unit 2102, and a pair of headphone speakers 2103. An earphone 2104 may be connected to a headphone body 2100A such that music is output from the pair of headphone speakers 2103 and earphone 2104.

The radio receiver 2101 receives in a reception unit 2101b via the antenna 2101a the digital data (PCM output signal) sent from the wristband-type music reproducing device 2200, demodulates it in a demodulator 2101c, decodes a resulting signal in a decoder 2101d and then sends a resulting signal to the music output unit 2102.

The music output unit 2102 converts the input digital music data to analog music signals in a pair of D/A converters 2102a, eliminates high-frequency components in a pair of LPFs (Low Pass Filters) 2102b, and audibly outputs resulting data from the pair of headphone speakers 2103 and/or earphone 2104.

In operation, it is assumed that the wristband-type music reproducing device 2200 is worn on the user's wrist or upper arm, that compressed encoded music data is stored on the memory card 209, and that the headphones 2100 is worn over the user's ears.

When the user sets the music mode with the corresponding one of the mode switches 203 provided on the wristband-type music reproducing device 2200, its control unit 2201 displays on the display unit 201 music reproduction information set in a first piece of music such as its title “TRK-1” and a performance time “00'00””. Then, when the user manipulates the input unit 202 for music reproduction, the control unit 2201 reads the piece of music corresponding to the “TRK-1” from the music data stored on the memory card 209 and stores it in the RAM 213 for reproduction of the music. The music data decoder 211 decodes the encoded music data and then sends resulting data to the radio transmitter 2202. Simultaneously, the decoder 211 sequentially sends the control unit 2201 data on the music reproduction information (music title, performance time, etc.,) extracted when the frame is decomposed in the music data decoder 211. The radio transmitter 2202 encodes and modulates the decoded digital music data for radio transmission and then sends resulting data to the headphones 2100. The control unit 2201 displays the music reproduction information on the display unit 201.

In the headphones 2100, when the radio receiver 2101 receives the digital music data, the voice output unit 2102 converts the received digital music data to analog music data, which is then output from the pair of headphone speakers 2103 or earphone 2104.

When the user manipulates the input unit 202 of the wristbandtype music reproducing device 2200 for fast feed- or rewind- reproduction or for stopping the reproduction, the control unit 2201 reproduces the music after fast feeding or rewinding the music or stops the music accordingly, at which time the control unit 2201 extracts the music reproduction information from the music data decoder 211, and displays the information on the display unit 201.

When one of the mode switches 203 of the wristband-type music reproducing device 2200 is operated to select the timepiece mode, the control unit 2201 displays on the display unit 201 the present time obtained in the timepiece 207. The control unit 2201 also corrects the present time in response to data on time correction input from the input unit 202, and displays a time representing a result of the correction on the display unit 201.

The wristband-type music reproducing device 2200 comprises music reproducing means such as the music data decoder 211 which reproduces music based on music data stored on the memory card 209, the radio transmitter 2202 which sends the headphones 2100 the music reproduced by the music reproducing means, the case 200 which contains the music data decoder 211 and the radio transmitter 2202, the pair of wristbands 301, 302 each attached one end to a respective one of the opposite ends of the case 200, and the pair of buckles 401 and 402 each connected to a respective one of the other ends of the wristbands 301 and 302 for wearing purposes. The input unit 202 is provided on the upper surface of the case 200 such that the input unit 202 worn on a wrist is operated at hand to cause the music reproducing means to reproduce music, which is then wirelessly sent to the headphones 2100 to thereby allow the user to listen to the music.

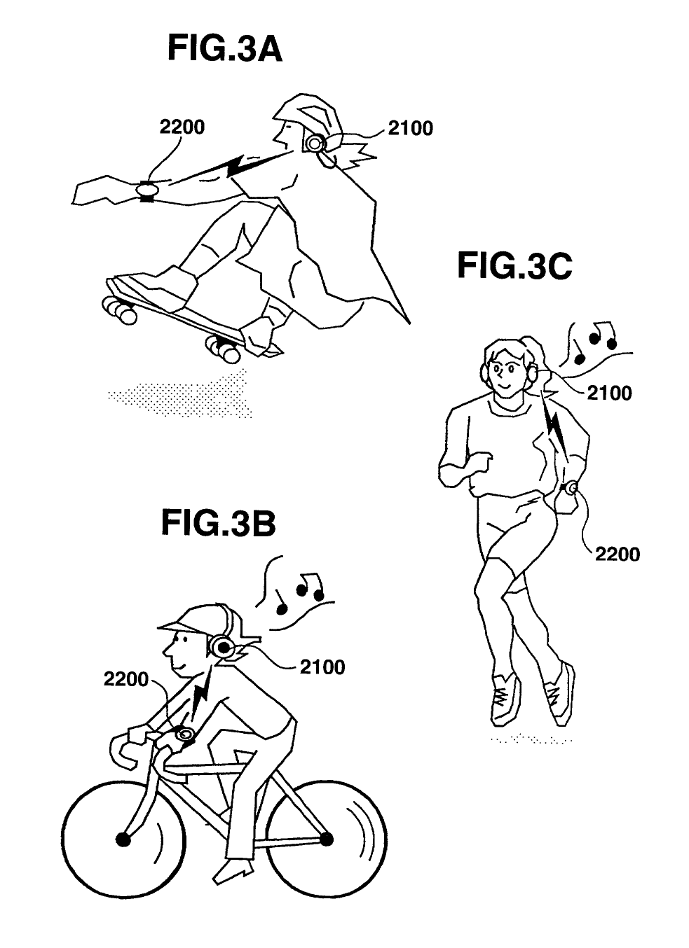

FIGS. 3A, B and C each illustrate an example of use of the music reproducing system 200, wherein the wristband-type music reproducing device 2200 is worn on the user's wrist and the pair of headphones 2100 are worn over his ears to listen to music provided by the headphones 2100 based on a corresponding music signal produced by the wristband-type music reproducing device 2200 in response to the user's manipulation. Thus, the user is able to move the parts of his or her body freely without being restricted by an earphone cord which would otherwise occur as in the prior art, for example, in skateboarding (vehement sport), bicycling, and jogging, respectively, shown in FIGS. 3A, B and C.

Since the input unit 202 is provided on the case 200 of the wristband-type music reproducing device 2200, the input unit 202 can be easily operated to reproduce or stop the music rapidly and easily with the reproducing device 2200 worn on the wrist.

Since data (melody title, singer's name, performance time, etc.) related to the music under reproduction is displayed on the display unit 201 of the wristband-type music reproducing device 2200, a user can manipulate the input unit for music reproduction while confirming the displayed music reproduction information.

By selecting the timepiece mode while listening to the music, the user can instantaneously confirm the time displayed on the display unit 201. When the music reproduction is not used, the user can remove the headphones 2100 from his head and put it into his bag and use the wristband-type music reproducing device 2200 as a general wristwatch.

Since the wristband-type music reproducing device 2200 receives the memory card 209 removably as the music data storage medium, it is convenient to carry, resists shocks and vibrations, and reproduces high quality music.

Since compressed encoded music data can be written to the memory card 209 via the connector 205 through the connection adapter from the external device 800, desired music data is easily acquired and reproduced anywhere and anytime when it is desired.

The details of the present invention are not limited to the above embodiment, but may be changeable appropriately in use without departing from the spirit of the present invention. For example, the headphones 2100 may comprise a music data decoder 211 and a radio receiver 2101 such that the compressed encoded music data read from the RAM 213 of the wristband-type music reproducing device 2200 is encoded and modulated by the radio transmitter 2202 to a radio transmit signal, which is then sent to the headphones 2100 which demodulates the signal received from the radio transmitter 2202, decodes resulting digital data in the music data decoder 211, D-A converts the resulting digital data from the decoder 211 to analog music data, which is then output audibly.

Alternatively, the wristband-type music reproducing device 2200 may comprise a music data decoder 211 and a music data output unit 2102 such that the compressed encoded music data stored in the RAM 213 is decoded to provide digital music data (PCM output signal), which is then converted to analog music data, which is then modulated by the radio transmitter 2202 and sent to the headphones 2100, and that the headphones 2100 demodulates the received analog music data and outputs it from the pair of headphone speakers 2103 and earphone 2104.

While the music data decoder 211 provided in the wristband-type music reproducing device 2200 is illustrated as decoding music data of an MPEG (Moving Picture Experts Group) audio code such as MP3, the encoding method is not limited to this encoding system. For example, another encoding system such as AAC (Advanced Audio Coding) or ATRAC (Adaptive Transform Acoustic Coding) or another plurality of encoding systems may be used.

While the input unit 202 is illustrated as being composed of switches and keys, as shown in FIG. 1, it is not limited to this particular case. It may have any shape or composition as long as it can input instruction data for music reproduction. For example, it may comprise a rotary switch to select or determine a melody. It may further comprise a volume control key and/or dial.

While the memory card 209 is illustrated as being set in the space 209A within the case 200 and protected from dropping out by the back cover, for example, the back cover may be fixed with screws. The memory card may be received within an openable cover for the space 209A, a cover for a battery compartment, a space provided in the case 200 through which the card is drawable, a card receiving section provided between the case 200 and a wristband 301 or 302, or a portion of the wristband 301 or 302. The memory card 209 may be protected from being wet with rain or water by a watertight packing.

The shapes of the buckles 401 and 402 are not limited to those shown in FIG. 1. If the wristband-type music reproducing device 2200 can be worn on a wrist with a pair of wristbands 301 and 302 with the aid of the corresponding the buckles 401 and 402, the buckles may take any forms.

### Second Embodiment

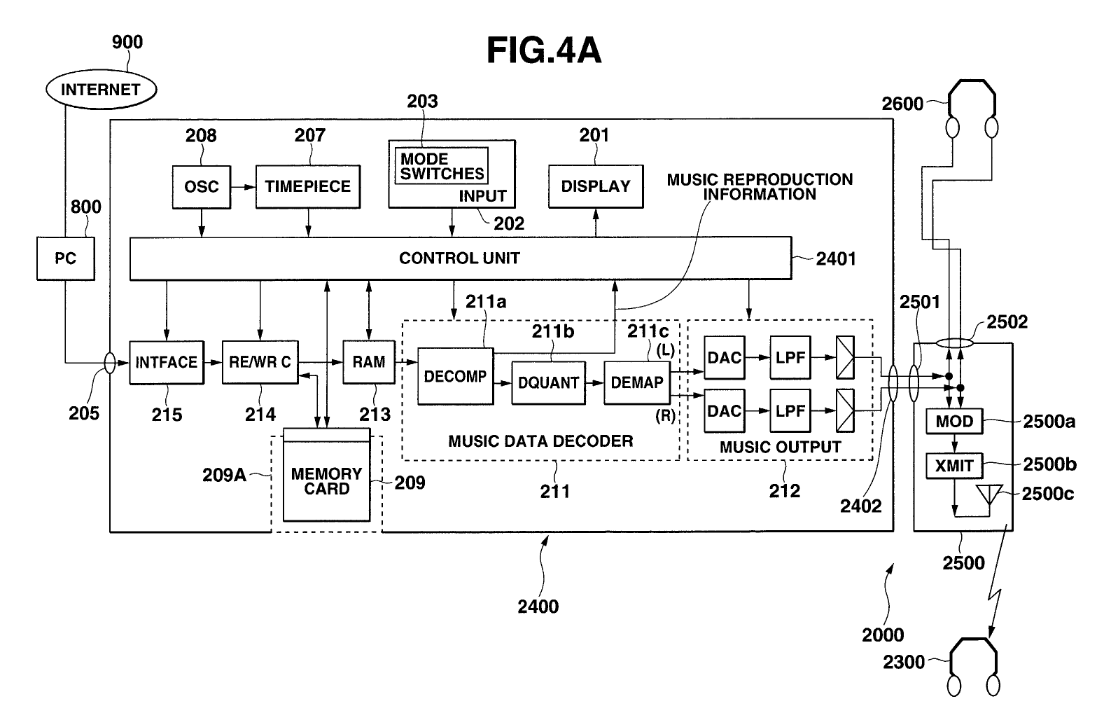

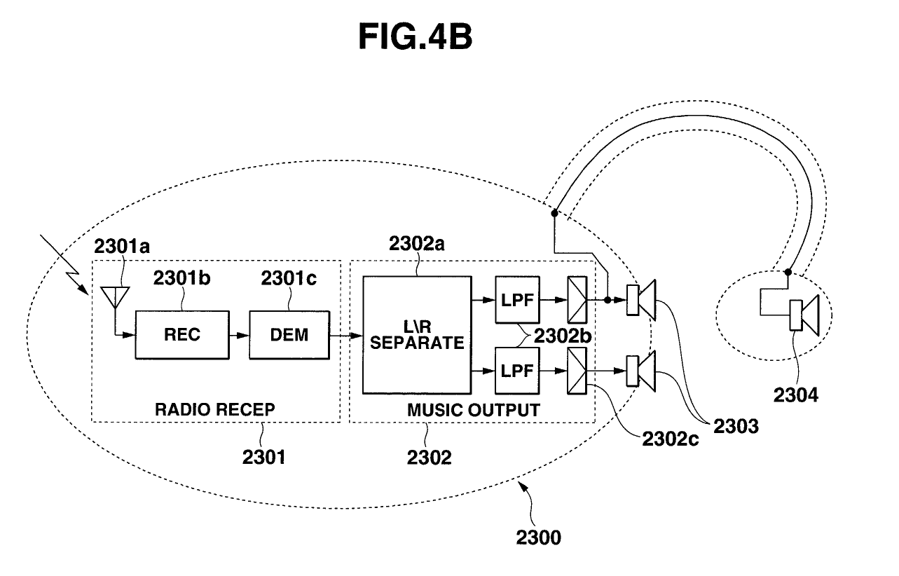

A second embodiment of the inventive music reproducing system 2000 will be described next with respect to FIGS. 4A and B which are block diagrams of a wristband-type music reproducing device 2400 and a wireless headphones 2300 which compose the system 2000.

In structure, the wristband-type music reproducing device 2400 comprises a removable radio transmission adapter 2500 which includes a radio transmitter so as to wirelessly communicate with the headphones 2300. The radio transmission adapter 2500 has a terminal 2501 connectable to a connector 2402 (FIG. 4) provided on a side of the case 200 of the wristband-type music reproducing device 2400. Thus, the radio transmission adapter 2500 receives music data via the terminal 2501 from the wristband-type-music reproducing device 2400, modulates it for radio transmission in a modulator 2500a, and then wirelessly sends it in a transmission unit 2500b via antenna 2500c to the headphones 2300.

The radio transmission adapter 2500 also functions as connecting means to the wired earphones 2600. In addition to the terminal 2501 connected to the connector 2402 of the wristband-type music reproducing device 2400, the radio transmission adapter 2500 comprises a largediameter earphone connector 2502 to be connected to the wired earphones 2600. Thus, the wired earphones 2600 used may be a one having a commercially available earphone jack of a general standard/size. The size of the wristband-type music reproducing device 2400 is neither required to be increased nor is an earphone having a dedicated jack required to be used.

In the following explanation, description of the outside and inside components of the wristband-type music reproducing device 2200 and headphones 2300 identical or similar to those of the wristband-type music reproducing device 2400 and headphones 2100 of the first embodiment of FIGS. 1 and 2 will be omitted, and those identical or similar components are identified with the same reference numeral.

The wristband-type music reproducing device 2400 of the second embodiment comprises a display unit 201, and an input unit 202 which includes mode switches 203, a timepiece 207, an oscillator 208, a control unit 2401, a music data decoder 211, a music output unit 212, a RAM (music data memory) 213, a read/write control unit 214, and an external interface 215 with a removable memory card 209.

The control unit 2401 reads compressed encoded music data from the memory card 209 set in the reception section 209A in response to the user's manipulation for reproduction at the input unit 202, and then stores it in the RAM 213. The music data decoder 211 decodes the music data. The music output unit 212 converts the decoded data to an analog signal, and then sends it to the radio transmission adapter 2500. When the earphone jack is connected to the connector 2502 in the adapter 2500, the analog music data is sent to the wired earphones 2600 to be output audibly from the wired earphones 2600. If the wired earphones 2600 is not connected, the analog music data is modulated for wireless transmission and then sent to the headphones 2300.

The internal circuit of the headphones 2300 of FIG. 4B will be described next. The headphones 2300 comprises a radio receiver 2301, a music output unit 2302, and a headphone speaker 2303. The headphones 2300 itself may be further connected to the earphone 2304 so as to provide outputs from the pair of headphone speakers 2303 and the earphone 2304.

The radio receiver 2301 receives in a reception unit 2301b via an antenna 2301a the analog music data sent by the wristband-type music reproducing device 2400, demodulates it in a demodulator 2301c, and then outputs the resulting signal to the music output unit 2302. The music output unit 2302 separates the demodulated analog music data into right and left signals in a separator 2302a, filters out high frequency components in a low pass filter (LPF) 2302b, and then outputs resulting signals to the pair of headphone speakers 2303 and earphone 2304.

In operation, it is assumed in the wristband-type music reproducing device 2400 that the memory card 209 which prestores compressed encoded music data is worn on the user's wrist or upper arm. It is also assumed that the headphones 2300 is set on the user's head so as to be put over the user's ears, and that the wristband-type music reproducing device 2400 is connected to the radio transmission adapter 2500.

When the user sets the music mode with a corresponding one of the mode switches 203 provided on the wristband-type music reproducing device 2400, the control unit 2401 of the wristband-type music reproducing device 2400 displays on the display unit 201 music reproduction information set for a piece of music such as a music title “TRK-1” and a performance time “01'10””. Then, when the user manipulates the input unit 202 for music reproduction, the control unit 2401 reads music data corresponding to the “TRK-1” from the music data stored on the memory card 209. The music data decoder 211 decodes the read music data. The music output unit 212 performs D-to-A conversion on the decoded music data and sends resulting analog data to the radio transmission adapter 2500. The radio transmission adapter 2500 sends the analog music data to the headphones 2300 and also sends sequentially the control unit 2401 the music reproduction information (music title, performance time, etc.) extracted in the frame decomposition performed by the music data decoder 211. The control unit 2401 then displays the music reproduction information on the display unit 201.

In the headphones 2300, the radio receiver 2301 receives the analog music data, the voice output unit 2302 separates the received analog music data into right and left music data, which are then output audibly from the pair of headphone speakers 2303 and earphone 2304.

When the user manipulates the input unit 202 of the wristband-type music reproducing device 2400 for fast feed- or rewind-reproduction or for a stopping purpose, the control unit 2401 performs a corresponding operation, that is, reproduces the music by fast feed or rewind operation or stops the music. Each time this occurs, the control unit 2401 displays on the display unit 201 music reproduction information extracted from the music data decoder 211.

When one of the mode switches 203 of the wristband-type music reproducing device 2400 is operated to select the timepiece mode, the control unit 2401 displays on the display unit 201 the time data obtained in the timepiece 207. The control unit 2401 also corrects the time in response to an instruction of correction to the time inputted at the input unit 202, and displays a resulting correct time on the display unit 201.

As described above, the music reproducing system 2000 of the second embodiment comprises the removable radio transmission adapter 2500 on the side of the wristband-type music reproducing device 2400. The radio transmission adapter 2500 has the connector 2502 to which the earphone jack is connected. Thus, the wired earphones 2600 may be connected to the connector 2502 for listening to the music or music data may be transmitted wirelessly so that the user may listen to the music with the wireless headphones 2300.

Thus, when music is to be reproduced, the radio transmission adapter 2500 is attached to the wristband-type music reproducing device 2400 such that the wired earphones 2600 or wireless headphones 2300 may be used as desired. When no music is reproduced, the radio transmission adapter 2500 may be removed from the wristband-type music reproducing device 2400 so that the music reproducing device 2400 may be used as a general timepiece. In that case, the music reproducing device 2400 becomes more compact than when it is worn on the wrist.

### Third Embodiment

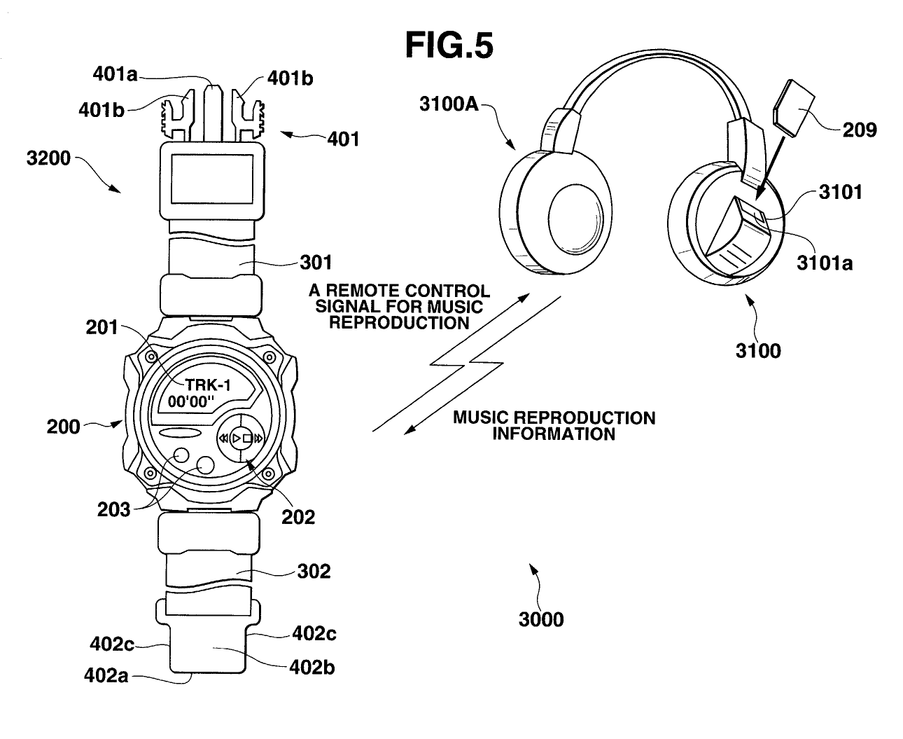

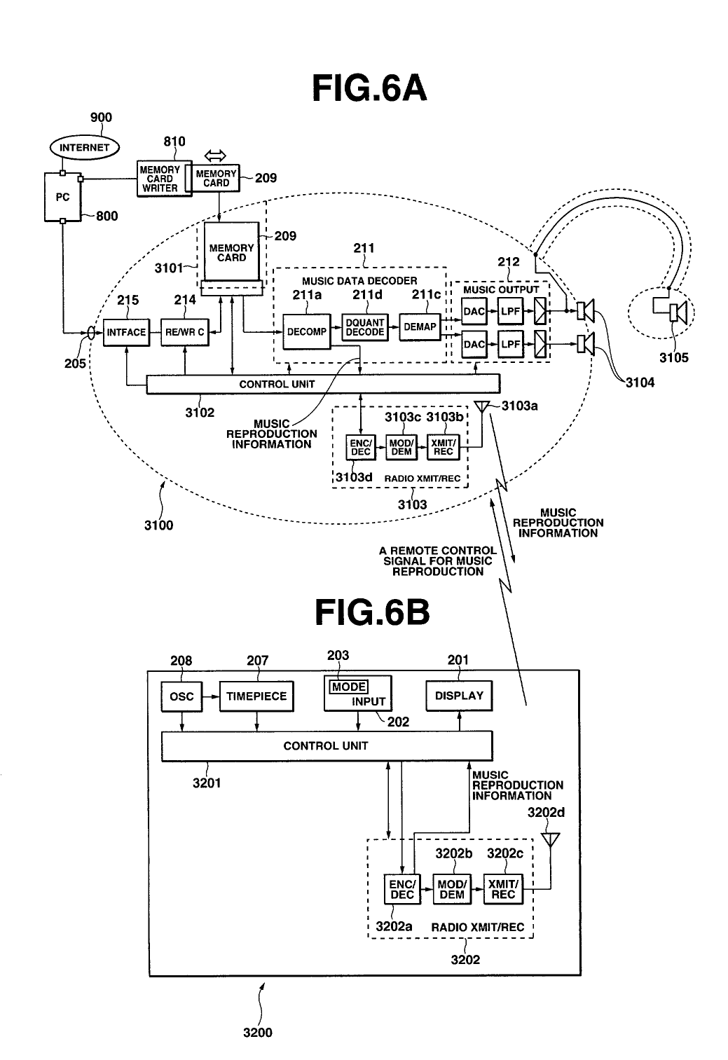

Referring to FIGS. 5 and 6, a music reproducing system 3000, which comprises a headphone-type music reproducing device 3100 and a wristband-type remote control device 3200, as a third embodiment of the present invention will be described next.

FIG. 5 shows the appearances of the headphone-type music reproducing device 3100, and the wristband-type remote control device 3200 connected wirelessly thereto. FIGS. 6A and B are block diagrams of the headphone-type music reproducing device 3100 and the wristband-type remote control device 3200, respectively.

The wristband-type remote control device 3200 comprises an internal circuit of FIG. 6B, a case 200 which contains the internal circuit, a pair of wristbands 301 and 302 each attached at one end to a respective one of the opposite edges of the case 200, and a corresponding pair of buckles 401 and 402 which are respectively connected to the other ends of wristbands 301 and 302 of the pair so as to be worn on the user's wrist or upper arm.

The wristband-type remote control device 3200 has the same appearance as the wristband-type music reproducing device 2200 of FIG. 1. Thus, the same reference numeral is used to denote similar elements of those devices, and further description thereof will be omitted.

The headphone-type music reproducing device 3100 has a slot 3101 in its body 31OOA in which a small memory card 209 comprising a semiconductor memory is set. Provided within the memory card slot 3101 are terminals (not shown) which are brought into contact with electrodes provided on the memory card 209 when the card 209 is placed in position in the slot such that data is read/written from/to the memory card 209 through the terminals and electrodes by a read/write control unit 214.

The shape of the memory card slot 3101 is not limited to that shown in FIG. 5. The memory card 209 may be set in a receiving section provided within the headphone body 3 100A and held by a cover so as not to drop out. The cover may be fixed, for example, with screws. Alternatively, the memory card may be set within an openable cover or battery compartment cover or within a drawer. In this case, for example, a watertight packing may additionally be used along with the cover so as to protect the memory card 209 from wetting with rain or water.

The headphone-type music reproducing device 3100 receives compressed encoded music data from an external device 800 such as a PC through a connector 205 and an adapter (not shown). A control unit 3102 writes the data to the memory card 209 and also reproduces music data stored in the memory card 209 in accordance with a remote control signal received from the wristband-type remote control device 3200.

Now, referring to FIGS. 6A and B, the circuit compositions of the headphone-type music reproducing device 3100 and the wristband-type remote control device 3200, and a whole composition of a music reproducing system 3000 which comprises the devices 3100 and 3200 will be described next.

As shown in FIG. 6A, the headphone-type music reproducing device 3100 comprises a control unit 3102, a music data decoder 211, a music output unit 212, a memory card 209, a read/write control unit 214, an external interface 215, a radio reception unit 3103, and a pair of headphone speakers 3104. The headphone-type music reproducing device 3100 may have an earphone 3105 so as to provide an additional audible output.

The control unit 3102 reads compressed encoded music data from the memory card 209 set in a slot 3101 provided in the headphone body 3100A in accordance with a remote control signal received by the radio transmission/reception unit 3103, decodes the music data in the music data decoder 211, D-A converts in the music output unit 212 the decoded data to analog data, which is then output audibly from the pair of headphone speakers 3104 or earphone 3105.

Receiving the compressed encoded music data from the external device 800 via the external interface 215, the read/write control unit 214 specifies a write location in the memory card 209 and writes the data there. The external device 800 may download the music data from the Internet 900. The external device 800 may write the downloaded music data to the memory card 209 with a memory card writer 810. Such memory card 209 may be set in the memory card slot 3101 of the headphone-type music reproducing device 3100 for use.

When the radio transmission/reception unit 3103 receives in a transmit/receive stage 3103b via an antenna 3103a a remote control signal from the wristband-type remote control device 3200, it demodulates and decodes the remote control signal in demodulating and decoding stages 3103c and 3103d, respectively, and then outputs a resulting signal to the control unit 3102. The radio transmission/reception unit 3103 encodes in an encoder/decoder 3103d according to a predetermined encoding system the music reproduction information extracted from the music data decoder 211, modulates it to a radio transmit signal in a modulate/demodulate stage 3103c and then sends the signal via the antenna 3103a to the wristband-type remote control device 3200 from the transmit/receive stage 3103b.

The music data decoder 211, music output unit 212, memory card 209, read/write control unit 214, and external interface 215 are identical in structure to the corresponding ones of the first embodiment, and hence further description thereof will be omitted. The same reference numeral is used to denote the same elements of the third and the first embodiments.

With reference to FIG. 6B, the circuit of the wristband-type remote control device 3200 will be described next which comprises a display unit 201, an input unit 202 comprising mode switches 203, a timepiece 207, an oscillator 208, a control unit 3201, and a radio transmission/reception unit 3202.

The control unit 3201 controls the wristband-type remote control device 3200 to perform operation corresponding to one of the timepiece and music modes determined based on a mode select key-in signal output from a corresponding one f the mode switches 203. In the timepiece mode, the control unit 3201 displays on the display unit 201 a date/time based on time data provided by the timepiece 207, or performs a timepiece function corresponding to data input at the input unit 202 and displays resulting data on the display unit 201.

In the music mode, the control unit 3201 sends the radio transmission/reception unit 3202 a remote control signal on music reproduction input at the input unit 202, and displays on the display unit 201 the music reproduction information received in the radio transmission/reception unit 3202 from the headphone-type music reproducing device 3100.

The radio transmission/reception unit 3202 encodes the remote control signal received from the control unit 3201 in an encode/decode stage 3202a according to a predetermined encoding method, modulates the encoded signal in a modulate/demodulate stage 3202b, and sends a resulting signal from the antenna 3202d to the headphone-type music reproducing device 3100 through a transmit/receive stage 3202c. The radio transmission/reception unit 3202 receives music related data from the headphone-type music reproducing device 3100 in the transmit/receive stage 3202c, demodulates it in the modulate/demodulate stage 3202b, decodes a resulting signal in the encode/decode stage 3202a and then delivers a resulting signal to the control unit 3201.

The display unit 201, input unit 202, timepiece 207, and oscillator 208 are identical in composition and operation to those corresponding ones of the first embodiment, and hence further description thereof will be omitted. The same reference numeral is used to denote the same or similar elements of the first and third embodiments.

In operation, it is assumed that the headphone-type music reproducing device 3100 is set over the user's ears, that the memory card 209 set in the memory card slot 3101 in the device body prestores a plurality of compressed encoded music data, and that the wristband-type remote control device 3200 is worn on the user's wrist.

When the user sets the music mode with the corresponding one of the mode switches 203 provided on the wristband-type remote control device 3200, the control unit 3201 of the remote control device 3200 displays on the display unit 201 music reproduction information for one piece of music such as a title of music “TRK-1” and a performance time “01'10””. Then, when the user inputs an instruction of music reproduction at the input unit 202, the control unit 3201 sends a remote control signal for music reproduction to the radio transmission/reception unit 3202 and thence to the headphone-type music reproducing device 3100.

When the headphone-type music reproducing device 3100 receives the remote control signal for music reproduction in the radio transmission/reception unit 3103, the control unit 3102 reads music data corresponding to the title of music “TRK-1” from the music data stored on the memory card 209, decodes it in the music data decoder 211. The music output unit 212 D/A-converts the decoded data, outputs a resulting signal audibly from the headphone speaker 3104, and sequentially outputs music reproduction information (music title, performance time, etc.) extracted in the frame decomposition to the control unit 3102, which then sends this information via the radio transmission/reception unit 3103 to the wristband-type remote control device 3200.

When the control unit 3201 of the wristband-type remote control device 3200 receives the music reproduction information, it displays the received information on the display unit 201.

When the user manipulates the input unit 202 of the wristbandtype remote control device 3200 for fast feed- or wind-reproduction or for a stopping purpose, the input unit 202 sends a corresponding remote control signal via the radio transmission/reception unit 3202 to the headphone-type music reproducing device 3100.

When the reproducing device 3100 receives the remote control signal from the remote control device 3200, it reproduces corresponding music in a fast-feeding or rewinding manner or stops reproduction of the music in accordance with the remote control signal. Each time this occurs, the control unit 3102 sends the music reproduction information, sent by the music data decoder 211, via the radio transmission/reception unit 3103 to the wristband-type remote control device 3200, which then displays the received information on the display unit 201.

When one of the mode switches 203 of the wristband-type remote control device 3200 is operated so as to select the timepiece mode, the control unit 3201 displays the time data counted by the timepiece 207 on the display unit 201, and also performs another timepiece function such as timepiece correction in accordance with the corresponding user's manipulation of the input unit 202.

As described above, in the music reproducing system 3000 of the third embodiment, the headphone-type music reproducing device 3100 has the memory card slot 3101 which removably receives the memory card 209. The music reproducing system 3000 also comprises the music reproducing section which in turn comprises the music data decoder 211 and the music output unit 212, and the radio transmission/reception unit 3103 which receives a remote control signal from the input unit 202 of the wristband-type remote control device 3200.

The wristband-type remote control device 3200 comprises the input unit 202 which is manipulated for music reproduction in the headphone-type music reproducing device 3100 and the radio transmission/reception unit 3202 which sends a remote control signal from the input unit 202 to the headphone-type music reproducing device 3100. The reproducing device 3100 reproduces music in accordance with the remote control signal received from the wristband-type remote control device 3200 and then outputs the music. Music reproduction information corresponding to the reproduced music is sent from the headphone-type music reproducing device 3100 to the wristband-type remote control device 3200 and the displayed on its display unit 201.

The wristband-type remote control device 3200 selects between the music and timepiece modes. In the music mode, the input unit is manipulated so as to reproduce music in the headphone-type music reproducing device 3100, and to display music reproduction information on the display unit 201. In the timepiece mode, the present time is displayed on the display unit 201 or other timepiece functions are performed.

In a state where the headphone-type music reproducing device 3100 is worn over the user's ears and the wristband-type remote control device 3200 is worn on the user's wrist or arm, music reproduction can be remotely controlled in the headphone-type music reproducing device 3100 in accordance with the user's manipulation of the wristband-type remote control device 3200.

In this case, as shown in FIGS. 3A, B and Ca the user can rapidly perform music reproduction easily even during sports or bicycling.

Since the wristband-type remote control device 3200 has the display unit 201 on which data related to the music under reproduction (the title of music, singer's name, a performance time, etc.) is displayed, the user can manipulate the input unit at hand for music reproduction while confirming the displayed music reproduction information.

The user can change the operation mode from the timepiece mode to the music mode and vice versa with the corresponding one of the mode switches 203 of the wristband-type remote control device 3200 so as to operate the headphone-type music reproducing device 3100 in the changed mode. For example, the user can select the timepiece mode during listening to the music so as to display the present time instantaneously on the display unit 201. That is, the wristband-type remote control device 3200 can be used as a general wristwatch.

Since the headphone-type music reproducing device 3100 is adapted to receive the small memory card 209 as a storage medium for music data, it is convenient to carry, resists shocks/vibrations sufficiently, and reproduces high-quality music.

Since in the music reproducing system 3000 compressed encoded music data can be written to the memory card 209 via the connector 205 from the external device 800 with the aid of the adapter, desired music data can be easily acquired and reproduced anytime and anywhere.

The details of the present invention may be changeable without departing from its spirit, and not limited to those of the first-third embodiments. For example, in the wristband-type music reproducing devices 2200 and 2400 of the first and second embodiments and in the headphone-type music reproducing device 3100 of the third embodiment, it is illustrated that the external device 800 acquires compressed encoded music data downloaded from the Internet 900 via the external device adapter or that the memory card writer 810 writes compressed encoded music data to the memory card 209, which is then put into the receiving section 209A or memory card slot 3101. However, the present invention is not limited to such illustrations.

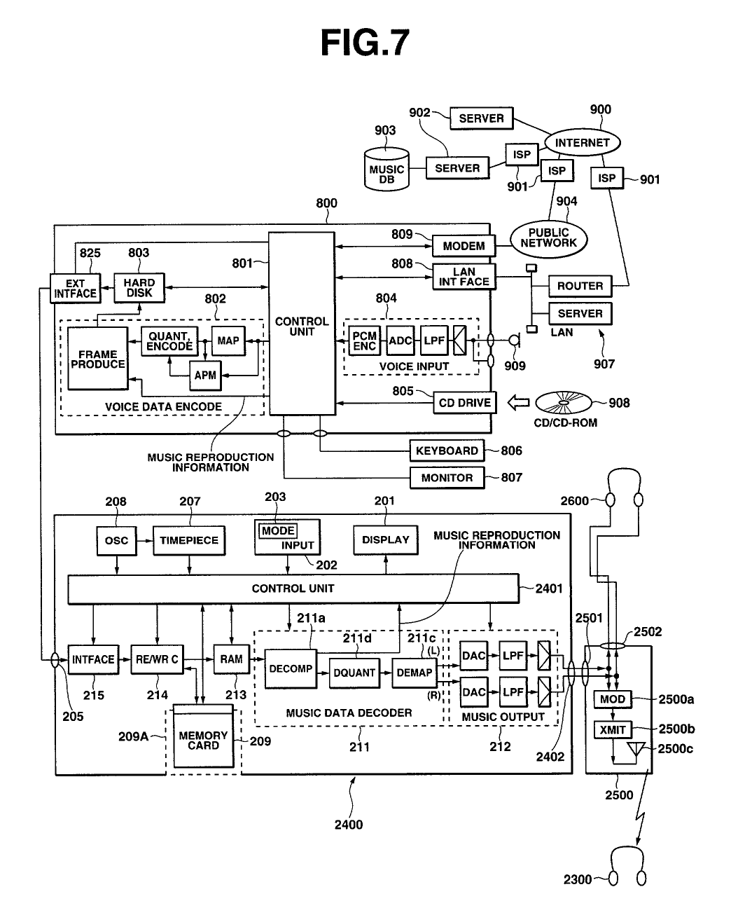

FIG. 7 is a block diagram of a music reproducing system which comprises the external device 800 and the wristband-type music reproducing devices 2400. As shown in FIG. 7, the external device 800 downloads compressed encoded music data from a sever 902 of the Internet 900, using a network connecting function of a modem 809 and a LAN (Local Area Network) interface 808, stores the data in a memory or storage device 803 of the hard disk, and then sends the data to the wristband-type music reproducing devices 2200, 2400 or headphone-type music reproducing device 3100.

Music or voice data provided by a microphone 909 may be converted to a PCM code in a voice input unit 804, and compressed and encoded in a predetermined encoding method in a voice data encoder 802 in which reference character APM denotes an auditory psychological model. This data may then be stored in the storage device 803, and then delivered to the wristband-type music reproducing devices 2200, 2400 or headphone-type music reproducing device 3100.

The external device 800 may compress and encode music data stored in a storage medium such as CD or a CD-ROM 908 at a predetermined bit rate and store it in the storage device 803, and then may deliver it to the wristband-type music reproducing devices 2200, 2400 or headphone-type music reproducing device 3100. Reference character PCM ENC denotes a PCM encoder.

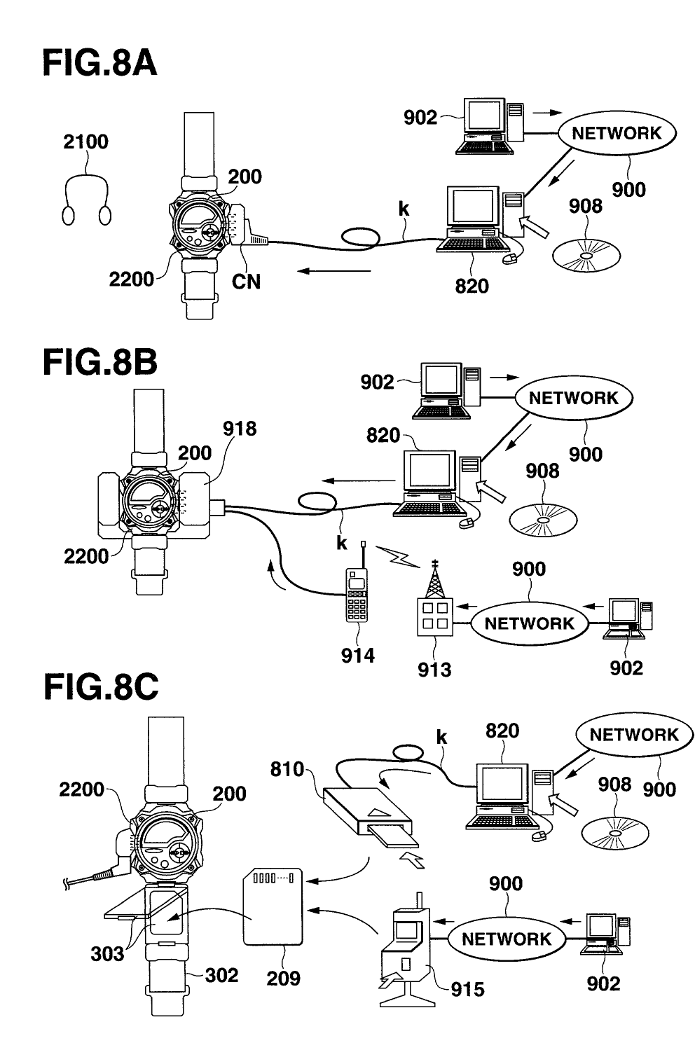

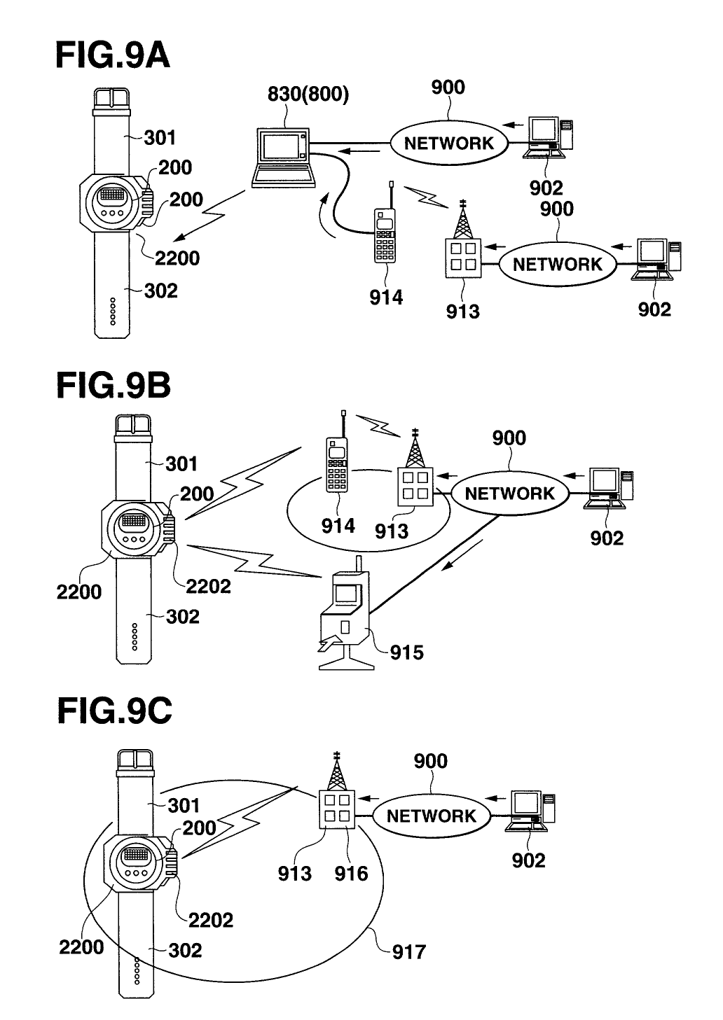

A method of connecting the wristband-type music reproducing device 2200 or 2400 or headphone-type music reproducing device 3100 to the external device 800 and a method of transmitting the encoded music data from the external device 800 to the reproducing device 2200, 2400 or 3100 is usable in various manners as shown in FIGS. 8A, 8B, 8C, 9A, 9B, and 9C, which will be described next.

FIG. 8A illustrates the wristband-type music reproducing device 2200 of the first embodiment connected with a personal computer 820 which is, in turn, connected to the network 900.

The external device 800 including the personal computer 820 comprises the storage device 803 and a driver 805 (CD/DVD drive) which reproduces data stored in a CD (Compact Disk), a CD-ROM or a DVD (Digital Versatile Disk) as shown in FIG. 7 so as to download compressed encoded music data from the server 902 via the network 900, to store the data in the storage device 803, to read music/image data stored in the optical disk set in the driver 805, and then to output the data.

The personal computer 820 has the data communicating function of sending music data stored in the storage device 803 or output by the driver 805 to the wristband-type music reproducing device 2200 in accordance with the user's instruction.

In FIG. 8A, the wristband-type music reproducing device 2200 is illustrated as being connected to the personal computer 820 through a serial or parallel cable K and a connector CN, and has a data communicating function of sending/receiving serial or parallel data to/from the personal computer 820.

In this case, the user of the wristband-type music reproducing device 2200 is able to download a desired piece of music data from a plurality of pieces of music data stored in the storage device 803 by manipulating the personal computer 820, to store it in the memory card 209, to select and reproduce desired music data in a music menu read from the optical disk by the driver 805, to download the reproduced music data onto the wristband-type music reproducing device 2200, and to store it on the memory card 209.

FIG. 8B illustrates the wristband-type music reproducing device 2200 connected through an adapter (or data writer) 918 by a serial or parallel cable K for to the personal computer 820 which is, in turn, connected to the network 900 or to a mobile communication terminal such as a portable telephone 914 which is, in turn, wirelessly connected to a base station 913 and hence to the network 900 such that the reproducing device 2200 may send/receive serial or parallel data to/from the personal computer 820 or mobile communication terminal 914.

The personal computer 820 has functions similar to those of the personal computer of FIG. 8A. The mobile communication terminal 914 receives music data sent wirelessly via a radio base station 913 from a server 902 connected to the network 900, and sends the received data to the wristband-type music reproducing device 2200 via the adapter 918 in accordance with the user's instruction. In this case, the user of the wristband-type music reproducing device 2200 uses the personal computer 820 in a manner similar to that shown in FIG. 8A.

The user of the wristband-type music reproducing device 2200 accesses the server 902 of the network 900 via the radio base station 913 from the mobile communication terminal 914 and wirelessly receives music menu information sent from a music data distribution site set on the server 902.

The user of the terminal 914 selects desired music data from the music menu displayed on its display unit. When the user receives the music data from the server 902, the user then sends the wristband-type music reproducing device 2200 the received data through the external adapter 918, and stores the data in the memory card 209.

FIG. 8C illustrates that a memory card 209 set removably in the receiving section 303 in the wristband 302 of the wristband-type music reproducing device 2200 stores music data received from the personal computer 820 or a data kiosk 915 (or a multimedia terminal such as a vending machine installed at a station or a convenience store).

The personal computer 820 has functions similar to those of the personal computer of FIG. 8A. It is connected via a cable K to an external memory card adapter 810, and has the functions of writing music data to the memory card 209 set in the memory card adapter 810 and reading the data written to the memory card 209.

The data kiosk or vending machine 915 has a built-in memory which stores music data, and has the functions of storing in the memory music data received from the server 902 via the network 900, writing on the set memory card 209 music data corresponding to a title of music input at the control panel, and issuing a debit note for the written music data.

In this case, the user of the wristband-type music reproducing device 2200 may set a prepared memory card 209 in the memory card adapter 810 connected to the personal computer 820, write the music data downloaded from the network 900 to the memory card 209 set in the memory card adapter 810, select and reproduce desired music data in a music menu read from an optical disk medium by the driver, and write the music data under reproduction to the memory card 209.

The user of the reproducing device 2200 may set the memory card 209 in position in the data kiosk 915, input a desired title of music at the control panel, confirm (for example, listens to) the contents of the music data stored in the memory of the data kiosk 915, cause the music data to be written to the memory card 209, and settle the user's accounts based on a debit note issued from the data kiosk 915.

Then, by setting the memory card 209 on which music data is written by the personal computer 820 or data kiosk 915 in the memory card receiving section 303 in the wristband-type music reproducing device 2200, the user is able to reproduce and listen to the newly written music.

Although the music reproducing device 2200 of the first embodiment has been described, the same applies to the wristband-type and headphone-type music reproducing devices 2400 and 3100 of the second and third embodiments, respectively.

FIG. 9A illustrates that the wristband-type music reproducing device 2200 has a radio data communicating function to receive music data wirelessly from the external device 800 comprising a portable information device such as a notebook type personal computer 830, and to store the data therein.

The wristband-type music reproducing device 2200 has a radio communicating function using infrared rays, electromagnetic induction or weak radio waves to perform radio communication with the notebook-type personal computer 830 having a radio communicating function similar to that of the reproducing device 2200 to thereby receive desired music data from the personal computer 830.

In addition to the radio communicating function using infrared rays, electromagnetic induction or weak radio waves, the personal computer has the function of connecting to the network 900 or a mobile communication terminal such as a portable telephone 914 to send/receive data to/from the network or portable telephone. The personal computer 830 downloads music data from the server 902 via the network 900, and stores it in the memory 803. The personal computer 830 also accesses the server 902 connected to the network 900 via the radio base station 913, wirelessly receives music menu information sent from the music data distribution service site set in the server 902, displays the received music menu information, selects desired music data from the music menu, receives the music data sent by the server 902 in response to the selection of the desired music data, and stores it in the memory 803.

In this case, the user of the wristband-type music reproducing device 2200 manipulates the notebook-type personal computer 830 connected thereto to access the server 902 on the network 900 connected by the cable to the connector 830 or the server 902 on the network 900 wirelessly connected to the mobile communication terminal 914 by the terminal 914 and base station 913, selects a desired title of music from the music menu information sent from the server 902, downloads the music data, and stores it in the memory 803.

When the user instructs the computer 830 to send the music data stored therein, the music data is wirelessly sent from the personal computer 830 to the wristband-type music reproducing device 2200 and stored on the memory card 209.

FIG. 9B illustrates that the wristband-type music reproducing device 2200 having a short-distance radio communicating function wirelessly receives and stores music data from a nearby mobile communication terminal 914 or data kiosk 915.

In this case, the user of the wristband-type music reproducing device 2200 may send a radio communication request to the mobile communication terminal 914 to connect to the same, cause the terminal 914 to access the server 902 connected to the network 900 via the radio base station 913, wirelessly receive from the terminal 914 the music menu information sent from the music data distribution service site set in the server 902, display it on the display unit of the reproducing device 2200, select desired music data from the music menu, receive the selected music data sent via the terminal 914, and store it in the memory card 209.

The user of the wristband-type music reproducing device 2200 may send a radio communication request to the data kiosk 915 having a wireless function to connect to the same wirelessly, wirelessly receive a music menu information from the kiosk 915, displays it on the display unit of the reproducing device 2200, select desired music data from the music menu, receive the selected music data sent via the kiosk 915 from the music data distribution service site set in the server 902, and store it in the memory card 209.

FIG. 9C illustrates that the wristband-type music reproducing device 2200 has a function of wirelessly communicating with a mobile terminal communication network 917 and a function of receiving radio waves broadcast by a broadcasting station 916 so as to receive and store desired music data the base station 913 or the broadcasting station 916 in the mobile terminal communication network 917.

The broadcasting station 916 or radio base station 913 of the mobile terminal communication network 917 has a function of downloading music data via a cable from a server 902 on the network 900 in response to a request to receive the music data from the wristband-type music reproducing device 2200.

In this case, the user of the wristband-type music reproducing device 2200 sends the radio base station 913 or broadcasting station 916 of the mobile terminal communication network 917 a request to connect wirelessly to the music data distribution server connected to the radio base station 913 or broadcasting station 916 thereby to access the server 902 connected to the network 900 via the radio base station 913 or the broadcasting station 916, wirelessly receives music menu information sent from the music data distribution service site set on the server 902, displays it on the display unit of the reproducing device 2200, selects desired music data from the music menu, receives the selected music data sent via the radio base station 913 or broadcasting station 916, and stores it on the memory card 209.

As described above, in the various manners shown in FIGS. 8A-8C, and 9A-9C, the wristband-type music reproducing device 2200 is usable. The wristband-type and headphone-type music reproducing devices 2200 and 3100 of the second and third embodiments are usable likewise in various manners.

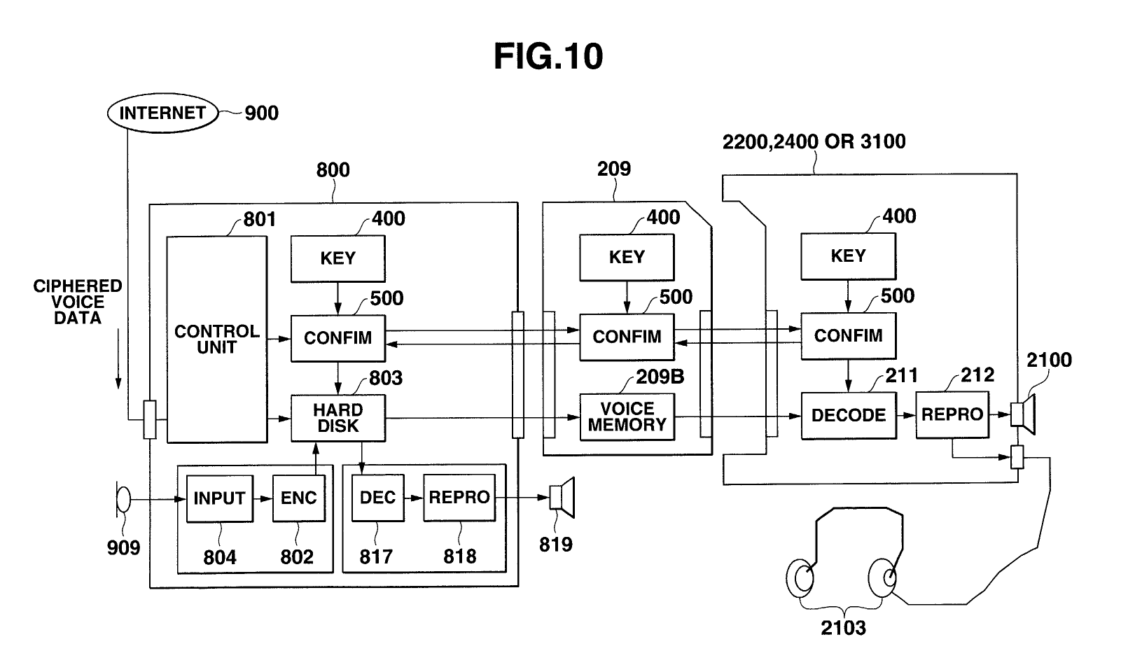

As shown in FIG. 10, the external device 800, memory card 209 and music reproducing devices 2200, 2400 or 3100 may have a function of protecting a music copyright. In this case, it is assumed that compressed encoded music data which the external device 800 downloads, for example, from the Internet 900 is beforehand ciphered. The external device 800, memory card 209, music reproducing devices 2200, 2400 and 3100 may mutually confirm that they are devices appropriate for protection of the music copyright, decode the ciphered music data, and then reproduce/output a corresponding signal as music.

FIG. 10 is a block diagram of connected external device 800, memory card 209 and music reproducing device 2200, 2400 or 3100 which each prestore a common key based on users' names or the like on a dedicated IC chip or in memory area, and confirm and cipher encoded music data and decipher the encoded music data based on the common key 400, the principle of which will be described next.

When the ciphered music data is downloaded from the Internet 900 by the external device 800, the data is stored in the memory (hard disk) 803, and confirmation data 500 corresponding to the ciphered music data is created by the control unit 801 based on the key 400.

Then, the music data stored in the memory 803 and corresponding confirmation data 500 are written to the memory card 209. Thus, in the memory card 209, the ciphered music data can be confirmed and decoded by the key 400 and the confirmation data 500 on the memory card 209.

Then, when the ciphered music data and the confirmation data 500 are read from the memory card 209 by the reproducing device 2200, 2400 or 3100, the reproducing device confirms and decodes the ciphered music data, reproduces and outputs corresponding music.

The confirming and decoding processes are performed by the common key 400 based on all the users' names whereas different keys are stored and set in respective external devices 800 which other users have. Thus, even when the ciphered music data is copied by a user to the external device 800 which another user has, the music data cannot be confirmed and decoded by the former user because the former user's key is different from the latter user's key. Reference numerals 212 and 818 each denote a voice reproducer.

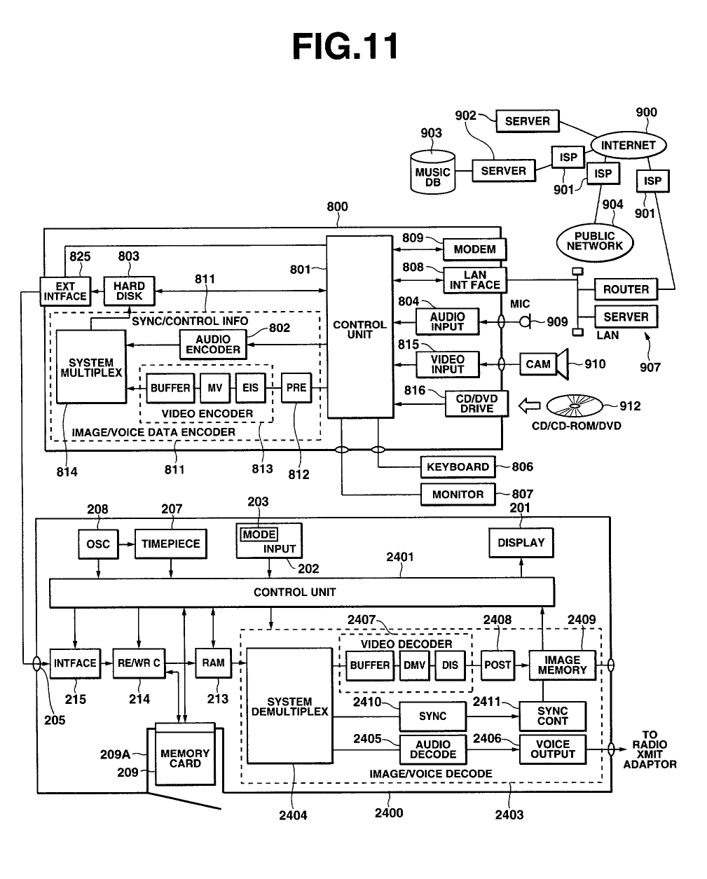

The data received from the external device 800 may comprise music data as well as image data. FIG. 11 is a block diagram of an external device 800 and a wristband-type music reproducing device 2400 connected thereto, each having an image data encoding/decoding function. As shown in FIG. 11, the external device 800 comprises an image/voice data encoder 811 which stores in the memory 803 digital encoded image/voice data downloaded from the Internet 900, compresses/encodes to a required bit rate the image/voice data stored in a storage medium such as a CD, CD-ROM or DVD 912, stores resulting data in the memory 803, encodes data on voice input to the microphone 909 or an image picked up by a camera 910, stores resulting data in the memory 803, and outputs the image/voice data stored in the memory 803 to the wristband-type music reproducing device 2400.

The wristband-type music reproducing device 2400 comprises an image/voice data decoder 2403 which decodes the encoded image data, displays resulting data on the display unit 201, and sends the decoded voice data via the radio transmission adapter 2500 to the headphones 2300.

FIG. 11 illustrates, as an example, the wristband-type music reproducing device 2400 of the second embodiment which additionally comprises an image/voice data decoder 2403 which decodes and reproduces voice and image data. In the wristband-type music reproducing device 2400, when a stream of the image and voice data stored in the memory 803 of the external device 800 is acquired via the external connection adapter, it is stored on the memory card 209. The stream of data stored on the memory card 209 is then read, stored in the RAM 213, and then decoded in the image/voice data decoder 2403 under control of the control unit 2401.

In the image/voice data decoder 2403, a system demultiplexor 2404 separates the image and voice data multiplexed in a single stream, the voice data is decoded by an audio decoder 2405 and is subjected to D-A conversion by a voice output unit 2406. The image data is decoded by a video decoder 2407, and frames of the decoded image data are rearranged in a post process unit 2408, and the resulting data is then stored in the image memory 2409. At this time, the voice and image are synchronously output from the voice output unit 2406 and the image memory 2409, respectively, based on sync information 2410. Thus, the image is displayed on the display unit 201, and the corresponding voice is sent via the radio adapter 2500 to the headphones 2300, which then outputs the voice audibly. Reference characters DVU and DIS denote a demultiplexed video unit and a decoded information source, respectively. Reference characters MVU and EIS denote a multiplexed video unit and an encoded information source, respectively. Reference numeral 812 denotes a preprocess unit.

The method of encoding the image data may comprise a JPEG (Joint Photographic Coding Experts Group) image encoding method, an MPEG image encoding method or any other encoding method. The image/music data may comprise a bit stream of encoded music data of an MPEG audio type which, in turn, comprises graphic display data/bit map image data inserted as external additional or bit map information.

As described above, the user is able to view at hand a music promotion video/a photographic image of a singer for the music displayed on the display unit 201 of the wristband-type music reproducing device 2400 while listening to the music with the headphones 2300. Thus, this music reproducing system becomes rich in entertainingness, expressiveness, and information quantity. The user is able to rapidly manipulate the input unit 202 at hand easily to reproduce an image/voice.

Similarly, the music reproducing devices 2200 and 3100 of the first and third embodiments each may comprise the image/voice data decoder 2403 to decode/reproduce an image and voice.

While in the above respective embodiments the headphone-type music reproducing devices which comprises a pair of ear pads applied to the user's ears and a band riding on the user's head so as connect both the ear pads are used, the present invention is not limited to these particular cases. For example, a neckband headphone-type music reproducing device may be used which comprises a pair of ear pads applied to the user's ears and a neckband placed so as to ride on the user's head back to support the pair of ear pads.

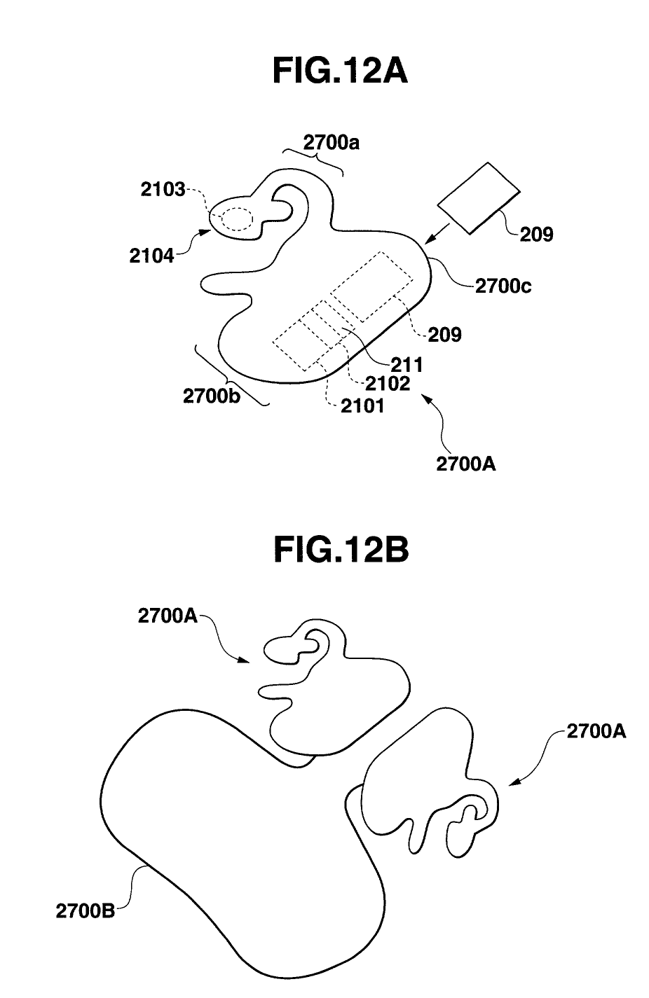

FIG. 12A illustrates an earphone-type music reproducing device 2700A of another embodiment. The music reproducing device 2700A comprises an earphone body 2104 which contains a speaker 2103, a curved area 2700a extending at one end from the earphone body 2104 so as to coincide substantially with an outline of an ear, and a device body 2700b connected to the other end of the curved area 2700a and containing an internal circuit which receives a memory card 209 to reproduce music. The device body 2700b has a slot 2700c in which the memory card 209 is settable, and comprises a music data decoder 211, a music output unit 2102 and a radio transmission/reception unit 2101 which reproduces music based on the music data stored on the memory card 209 or built-in music memory.

In use, the earphone-type music reproducing device 2700A is set such that the curved area 2700a is put on a corresponding ear of the user and the earphone body 2104 is applied lightly to or inserted into a corresponding ear of the user such that the music data sent wirelessly by the reproducing device 2200 is received by the radio receiver 2101 and output by the music output unit 2102. Music is reproduced in the music data decoder 211d based on the music data stored on the memory card 209 or built-in music memory in accordance with the remote control signal sent from the wristband-type remote control device 3200 and received by the radio receiver 2101, and then output from the music output unit 2102.

As shown in FIG. 12B, a pair of earphone-type music reproducing device 2700A connected electrically by a cord 2700b may be used to reproduce music in a stereophonic manner from a corresponding pair of speakers 2103 contained therein. Music data stored on one of a pair of memory cards 209 set in the corresponding pair of reproducing devices 2700A may be reproduced sequentially.

In place of such pair of earphone-type music reproducing devices 2700A, a removable memory card 209, a built-in music memory, a music reproducing unit and a radio receiver may be provided in a hearing aid-type earphone.

What is claimed is:

1. A music reproducing apparatus comprising:
a body wearable over a user's ear;
a semiconductor music data storage device provided removably within said body and prestoring music data;
music reproducing means provided within said body for reproducing music based on music data stored in said music data storage device;
receiving means provided within said body for receiving a remote control signal externally; and
music reproduction control means for controlling reproduction of music in said music reproducing means based on the remote control signal received by said receiving means.

2. A music reproducing system comprising an earphone-type music reproducing device and a wristband-type remote control device,
said earphone-type music reproducing device comprising:
a body wearable over a user's ear;
a semiconductor music data storage device provided removably within said body and prestoring music data;
music reproducing means provided within said body for reproducing music based on music data stored in said music data storage device;
receiving means provided within said body for receiving a remote control signal from said wristband-type remote control device; and
music reproduction control means for controlling reproduction of music in said music reproducing means based on the remote control signal received by said receiving means.
said wristband-type remote control device comprising;
input means for inputting data to remotely control reproduction of music in said earphone-type music reproducing device; and
sending means for sending said earphone-type music reproducing device a remote control signal to remotely control reproduction of the music based on the data input by said input means.

3. The music reproducing system according to claim 2, wherein said earphone-type music reproducing device further comprises:
data transmitting means for transmitting to said wristband-type remote control device information on music reproduced by said music reproducing means; and wherein said wristband-type remote control device comprises:
a display unit;
data receiving means for receiving information on the music sent by said earphone-type music reproducing device; and
display control means for displaying on said display unit information on the music received by said data receiving means.

4. The music reproducing system according to claim 3, wherein the remote control signal and the information on the music are wirelessly sent/received between said earphone-type music reproducing device and said wristband-type remote control device.

5. The music reproducing system according to claim 2, wherein said wristband-type remote control device comprises:
a display unit;
timepiece means for counting time; and
display control means for causing said display unit to display the time counted by said timepiece means.

6. The music reproducing system according to clam 5, wherein said wristband-type remote control device comprises:
mode setting means for setting one of a timepiece mode and a music mode; and
control means, responsive to said mode setting means setting the timepiece mode, for controlling said wristband-type remote control device to display the time counted by said timepiece means on said display unit, and responsive to said mode setting means setting the music mode, for controlling said wristband-type remote control device to enable data to be inputted to said input means.

7. A music reproducing system comprising an earphone-type music hearing device for enabling the user to hear music, and a wristband-type music reproducing device wearable on the user's wrist,
said wristband-type music reproducing device comprising:
music data storage means for prestoring music data;
input means for inputting data to reproduce music;
music reproducing means for reproducing a music signal based on music data stored in said music data storage means in accordance with the data to reproduce music which is input by said input means; and
radio transmitting means for wirelessly transmitting the music signal reproduced by said music reproducing means to said earphone-type music hearing device, and
said earphone-type music hearing device comprising:
receiving means for receiving the music signal sent by said radio transmitting means; and
music output means for outputting music based on the music signal received by said receiving means.

8. The music reproducing system according to claim 7, wherein said radio transmitting means is provided removably in said wristband-type music reproducing device.

9. The music reproducing system according to claim 7, wherein said wristband-type music reproducing device comprises:
a display unit; and
display control means for causing said display unit to display information on the music signal reproduced by said music reproducing means.

10. The music reproducing system according to claim 7, wherein said wristband-type remote control device comprises:
a display unit;
timepiece means for counting time; and
display control means for causing said display unit to display the time counted by said timepiece means.

11. The music reproducing system according to clam 10, wherein said wristband-type remote control device comprises:
mode setting means for setting one of a timepiece mode and a music mode; and
control means, responsive to said mode setting means setting the timepiece mode, for controlling said wristband-type remote control device to display the time counted by said timepiece means on said display unit, and responsive to said mode setting means setting the music mode, for controlling said wristband-type remote control device to enable said music reproducing means to reproduce music or to enable data to be inputted to said input means.
